(19) United States
(12) Patent Application Publication
(10) Pub. No.: US 2007/0069881 A1
(43) Pub. Date: Mar. 29, 2007

(54) Vehicle U-turn safety signal device

(76) Inventor: Jewel L. Dohan, Newport Beach, CA (US)

Correspondence Address: RUTAN & TUCKER, LLP;Robert D. Fish, 611 ANTON BLVD, SUITE 1400, COSTA MESA, CA, 92626, US

(21) Appl. No.: 11/540,447

(22) Filed: Sep. 28, 2006

Related U.S. Application Data
(60) Provisional application No. 60/722,057, filed on Sep. 29, 2005.
(60) Provisional application No. 60/788,140, filed on Mar. 31, 2006.

(51) Int. Cl. B60Q 1/34

(52) U.S. Cl. 340/465

(57) ABSTRACT

A safety device for use in a motor vehicle is provided. The device may be a signal to indicate a U-turn by the vehicle driver to alert oncoming and following traffic of the driver's intent to make a U-turn. The safety device may be configured in a variety of different embodiments, including factory specification, original equipment (OEM) and/or after-market embodiments. The device may have a wireless communication between a signaling unit and a transmitting unit. The device may be battery operated having a signaling unit and receiving unit and at least one actuating, transmitting unit. The aftermarket device may have a batter operated signaling unit that is directly actuated by the driver and which in turn actuates at least one additional signaling unit via wireless communication. OEM devices may be hard-wired to the vehicles electrical system and may not require any wireless communication and/or battery power.

This application claims priority to U.S. Provisional application Ser. No. 60/788,140 filed Mar. 31, 2006 and Ser. No.: 60/722,057 filed Sep. 29, 2005.

### FIELD OF THE INVENTION

The invention relates generally to the field of vehicle safety devices. More specifically, the present invention relates to a vehicle safety signal device to be utilized in a vehicle to indicate the driver's desire to make a U-turn.

### BACKGROUND OF THE INVENTION

One of the problems with many drivers in today's society is the lack of signaling before making a turn or changing lanes. This problem is compounded when a driver is making a right turn or left turn in a marked lane. Many individual drivers will not signal if they are in a designated turn lane. However, one problem that exists is for drivers that are making U-turns in left turn designated lanes. There may be significant dangers even if the driver signals to make the turn.

The danger of only signaling a left or right turn does not indicate to oncoming or following vehicles the path the signaling driver intends to make, whether in a passenger car, Sports Utility vehicle, van, truck or motorcycle. Hence, following drivers may believe that the driver in front of them is actually making a standard left turn and follow the car accordingly. However, the larger arc required for a U-turn encumbers the path of the unsuspecting following driver and endangers both or other following vehicles. The oncoming traffic, whether on a side street without traffic signals or at an intersection are likewise uninformed and unaware that the signaling driver's intention is to make a U-turn and not a left turn and many traffic accidents occur this way.

Similarly, vehicles that may be at a corner of an intersection may see a left hand turn indicator (in other countries, this may be a right hand turn indicator) and believe that the driver intends to make a standard left hand turn and that the indicating vehicle will not be in the same path of travel as the vehicle at the corner of an intersection. The driver making the U-turn will then travel in the same path as the vehicle turning at the corner of the intersection and serious collisions may occur.

The problem of U-turns has been recognized by others in the art, who have tried to develop U-turn signals. For example, U.S. Pat. No. 5,281,950 issued to Lee, U.S. Pat. No. 4,868,541 issued to Sullivan et al., U.S. Pat. No. 4,387,361 issued to Reed and U.S. Pat. No. 6,043,740 issued to Tan, whose disclosures are incorporated herein in their entireties by reference thereto.

Additionally, the use of speech recognition technology has become more commonplace in today's society. Many different devices from phones and computers to lighting can be manipulated and directed through the use of speech recognition technology. A voice activation capability

These prior art references attempted to design U-turn signals but have failed to provide a simple, economical U-turn signal, that is easily installed using and RF transmitter/receiver rather than an ultrasonic signal generator. Additionally, the prior art reference typically involve some alterations to the vehicle's electrical system or changes to the vehicle body/interior. In addition, none of the aforementioned prior art detail the front signal U-turn device designed to be visible in daylight as well as at night to vehicles facing the driver that wishes to make a U-turn.

Accordingly, a need therefore still exists for a U-turn signal that effectively provides a simple aftermarket installation requiring little to no tools or electrical connections. Additionally, a need therefore exists for an improved signaling device for drivers wishing to make a U-turn wherein the device is easy to manufacture and install.

Moreover, a need therefore exists for a cost effective and efficient U-turn signal that will indicate a driver's desire to make a U-turn. Additionally, a need therefore exists for a U-turn signal that integrates speech recognition technology.

### SUMMARY OF THE INVENTION

The present invention relates to a safety device for use in a motor vehicle. The device may be a signal to indicate a U-turn by the vehicle driver to alert oncoming and following traffic of the driver's intent to make a U-turn. The safety device may be configured in a variety of different embodiments, including factory specification, original equipment (OEM) and/or after-market embodiments. The device may have a wireless communication using radio frequency between a signaling unit and a transmitting unit. The device may be battery operated having a signaling unit and receiving unit and at least one actuating, transmitting unit. The aftermarket device may have a battery operated signaling unit that is directly actuated by the driver and which in turn actuates at least one additional signaling unit via wireless communication. OEM devices may be hard-wired to the vehicles electrical system and may not require any wireless communication and/or battery power.

In an exemplary embodiment the present invention is directed toward a wireless vehicle safety system. The system has a U-Turn signal device configured to illustrate a driver's desire to make a U-turn. Additionally the system has a transmitting unit and a receiving unit wherein the receiving unit activates the U-turn signal device.

In an exemplary embodiment, the wireless vehicle safety system has a U-turn signal device including an insertable plate.

In an exemplary embodiment, the wireless vehicle safety system has a power source to power the U-turn signal device.

In an exemplary embodiment, the wireless vehicle safety system has a safety device that is removably attached to an interior portion of a vehicle.

In an exemplary embodiment, the wireless vehicle safety system has an attachment means wherein the attachment means has an arm and a plurality of connection portions wherein the connection portions attach to the u-turn signal device and further wherein the connection portion attaches to a portion of the interior of a vehicle.

In an exemplary embodiment, the wireless vehicle safety system has a plurality of flashing lights incorporated into the U-turn signal device.

In an exemplary embodiment, the wireless vehicle safety system has a power source to activate the U-turn signal device.

In an exemplary embodiment, the wireless vehicle safety system has an indicator adapted for placement in the interior portion of a vehicle to indicate to the driver that the U-turn signal device is activated.

In an exemplary embodiment, the wireless vehicle safety system has a voice activation mechanism wherein upon voice recognition, the U-turn signal device is activated.

In an exemplary embodiment of the present invention, a vehicle safety device is provided. The device has a container means for housing the device and at least a light source whereby the light source is housed within the container means. Additionally, the device has a receiver unit to receive a signal from a transmitting unit and a power source to power the light source of the device.

In an exemplary embodiment, the wireless vehicle safety system has an actuator wherein the actuator activates the vehicle safety device.

In an exemplary embodiment, the wireless vehicle safety system has an attachment means for attaching the device to a portion of a vehicle.

In an exemplary embodiment, the wireless vehicle safety system has an activator having a light source thereon to indicate to a driver that the device has been activated.

In an exemplary embodiment, the wireless vehicle safety system has a voice activation system whereby the voice activation system activates the transmitting unit to send a signal to the receiving unit which in turn activates the vehicle safety device.

To this end, in an exemplary embodiment of the present invention, a method for using a wireless vehicle safety system, said method comprising the steps of: providing a U-Turn signal device configured to illustrate a driver's desire to make a U-turn wherein the U-turn signal device contains a plurality of light sources to illuminate the signal device indicating a driver's intention to make a U-turn; providing a transmitting unit; and providing a receiving unit wherein the receiving unit activates the U-turn signal device.

In an exemplary embodiment, the method further comprises the step of: a driver utilizing an actuation button.

In an exemplary embodiment, the method further comprises the step of: sending a wireless signal to the receiving unit to activate the U-turn signal device. In an exemplary embodiment, the method comprises the step of: providing a power source to power the wireless transmitting unit, receiving unit and U-turn signal device.

In an exemplary embodiment, the method comprises the step of: providing an indicator mechanism whereby the indicator mechanism indicates to the driver that the U-turn signal device is operating or not operating.

In an exemplary embodiment, the wireless vehicle safety system allowing the driver to cancel the U-turn signal device whereby the driver de-activates an actuation button to cancel the signal device.

To this end, in an exemplary embodiment of the present invention, a vehicle safety device is provided. The safety device has an indicator thereon.

In another exemplary embodiment, a vehicle safety device is provided. The device has an U-turn indicator displayed thereon to alert other drivers that the driver wishes to make a U-turn.

Yet another exemplary embodiment of the present invention is to provide a safety device for placement in any vehicle to indicate the driver's desire to make a U-turn.

Still another exemplary embodiment of the present invention is to provide a safety device that may be adapted for OEM use.

An exemplary embodiment of the present invention is to provide a safety device having an actuator means that may be coupled to the receiving unit.

Another exemplary embodiment of the present invention is to provide a safety device that may be adapted for aftermarket use.

Yet another exemplary embodiment of the present invention is to provide a safety device wherein the device may be pressure sensitive.

Another exemplary embodiment of the present invention is to provide a safety device wherein the safety device may use flashing lights, sequential and/or on/off switches.

Still another exemplary embodiment of the present invention is to provide a safety device that may be adapted for use in a vehicle wherein the device may be retrofitted to any existing vehicle.

Yet another exemplary embodiment of the present invention is to provide a safety device that is adapted for vehicle use wherein the device is battery powered.

In yet another exemplary embodiment of the present invention is to provide a safety device that is adapted for vehicle use wherein the device may be hard-wired into a vehicle.

Another exemplary embodiment of the present invention is to provide a safety device wherein the device may be activated and de-activated by voice recognition.

Still another exemplary embodiment of the present invention is to provide a safety device that may be utilized in a vehicle wherein the device may be a wireless system.

A further exemplary embodiment of the present invention is to provide a safety device that may utilize battery power to activate and de-activate the safety device.

Another exemplary embodiment of the present invention is to provide a safety device wherein the device may have a U-turn LED flashing signal positioned at the rear of the car to inform vehicles behind the vehicle with the device of that individuals desire to make a U-turn.

Yet another exemplary embodiment of the present invention is to provide a safety device wherein the device may have a U-turn LED flashing signal positioned at the front of the car to inform vehicles facing and across roads/intersections from the vehicle with the device wherein the device indicates an individuals desire to make a U-turn.

Still another exemplary embodiment of the present invention is to provide a safety device wherein the device may have a U-turn LED flashing signal positioned at the front and the rear of the vehicle to inform traffic in front and behind the vehicle of that individual's desire to make a U-turn.

A further exemplary embodiment of the present invention is to provide a safety device wherein the device may be voice activated.

Yet another exemplary embodiment of the present invention is to provide a safety device wherein the device may be positioned within the OEM turn lights.

A further exemplary embodiment of the present invention is to provide a safety device which may be placed externally on the outside portion of a vehicle.

Still another exemplary embodiment of the present invention is to provide a safety device which may be placed internally on the inside portion of the vehicle.

Yet another exemplary embodiment of the present invention is to provide a safety device system wherein the system may be used by a plurality of different types of vehicles including commercial, business, person vehicles, cars, ambulances, military, police vehicles, motorcycles among others.

Another exemplary embodiment of the present invention is to provide a safety device wherein the device may be placed in the windows, windshield, wipers, seats or any other place that may be visible to other surrounding vehicles.

Still another exemplary embodiment of the present invention is to provide a safety device wherein the safety device may be voice activated in both OEM and aftermarket versions of the device.

Yet another exemplary embodiment of the present invention is to provide a safety device wherein the device may have replaceable battery systems.

Another exemplary embodiment of the present invention is to provide a safety device wherein the device may have rechargeable battery systems wherein the unit may be plugged into a electrical outlet to recharge the device.

Still another exemplary embodiment of the present invention is to provide a safety device wherein the device may use a standard bulb used in OEM turn signals.

A further exemplary embodiment of the present invention is to provide a safety device wherein the device may utilize LED flashing signal units and/or standard turn halogen bulbs.

Another exemplary embodiment of the present invention is to provide a safety device wherein the device is easily installed into existing vehicles.

Yet another exemplary embodiment of the present invention is to provide a safety device wherein the device may be easily incorporated into new cars from the factory.

Still another exemplary embodiment of the present invention is to provide a safety device wherein the device may have a transmitting unit and a receiving unit.

Another exemplary embodiment of the present invention is to provide a safety device wherein the device may have a transmitting unit and a receiving unit wherein the transmitting unit and the receiving unit communicate with each other in a wireless manner.

A further exemplary embodiment of the present invention is to provide a safety device wherein the device may have a transmitting unit and a receiving unit wherein the transmitting unit and the receiving unit communicate with each other in a non-wireless manner.

Yet another exemplary embodiment of the present invention is to provide a safety device wherein the safety device may be remote controlled.

Still another exemplary embodiment of the present invention is to provide a safety device wherein the device does not impeded driver visibility.

Another exemplary embodiment of the present invention is to provide a safety device wherein the device may have a sending unit wherein the sending unit is a radio frequency system.

Yet another exemplary embodiment of the present invention is to provide a safety device wherein the safety device may have a sending unit wherein the sending unit is a RF activated circuit board using a UHF signal which does not require a line-of-sight transmission.

Another exemplary embodiment of the present invention is to provide a safety device wherein the device may be positioned within a container.

Still a further exemplary embodiment of the present invention is to provide a safety device wherein the device may have a plurality of sending units and a plurality of receiving units.

Yet another exemplary embodiment of the present invention is to provide a safety device wherein the device may be activated by using a button on the standard turn signal stock located on the steering column of most vehicles.

Yet a further exemplary embodiment of the present invention, the safety device wherein the device may be activated by using a button on the standard turn signal stock located on the steering column of most vehicles or may be voice activated by the individual driving the vehicle.

Still a further exemplary embodiment of the present invention is to provide a safety device wherein the device may be removed from one vehicle and installed in another vehicle if desired.

In a further exemplary embodiment of the present invention, the safety device may be housed in a container wherein the container may be made of plastic, metal, or any other suitable material.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 is a front perspective view of the safety device in an exemplary embodiment of the present invention;

FIG. 2 is a front perspective view of the safety device in an exemplary embodiment of the present invention;

FIG. 3 is a front perspective view of the actuator unit with a reminder light of the safety device in an exemplary embodiment of the present invention;

FIG. 4 is rear view of the safety device in an exemplary embodiment of the present invention;

FIG. 5 is a side perspective view of the attachment means in an exemplary embodiment of the present invention;

FIG. 6 is a front perspective view of the safety device and insert in an exemplary embodiment of the present invention;

FIG. 7 is a front view of the steering wheel of a vehicle illustrating the use of the safety device in an exemplary embodiment of the present invention;

FIG. 8 is a schematic of the electrical system of the safety device in an exemplary embodiment of the present invention;

FIG. 9 is an illustration of the safety device circuitry added to an OEM turn signal in an exemplary embodiment of the present invention;

FIG. 10 is a flow chart illustrating the voice activation system in an exemplary embodiment of the present invention; and

FIG. 11 is a flow chart illustrating the signal sequence in an exemplary embodiment of the present invention.

### DETAILED DESCRIPTION

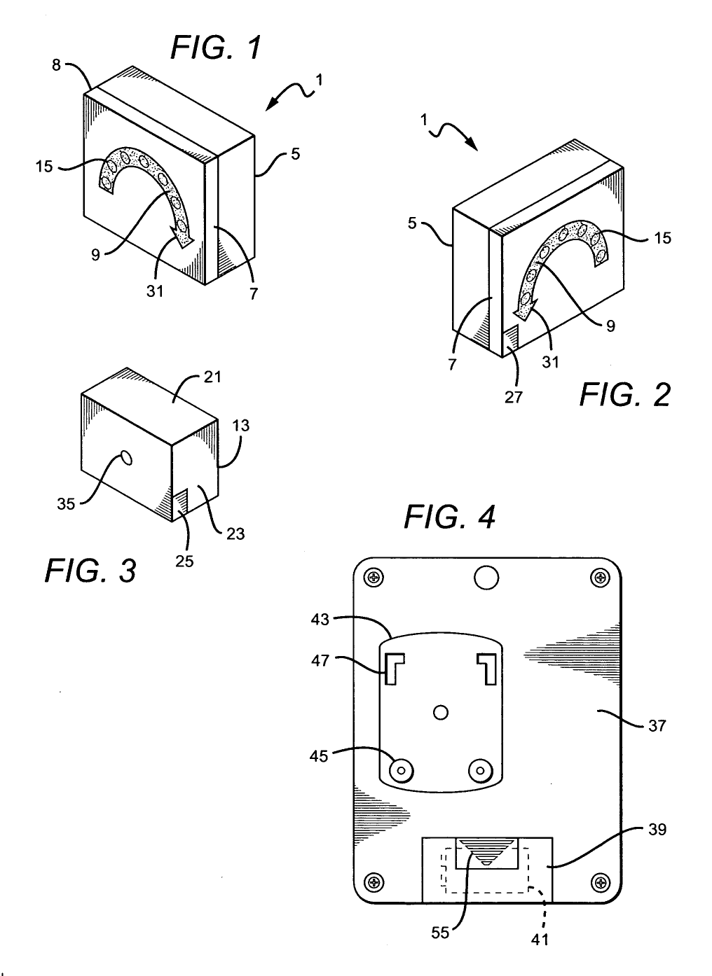

Turning now to the drawings wherein elements are identified by numbers and like elements are identified by like numbers throughout the 10 figures, the invention is depicted in FIG. 1 and illustrates a safety device 1 to be used in a moving vehicle.

Referring first to FIG. 1, a safety device system 1 is provided. The safety device 1 may include in an exemplary embodiment, a container means 5 wherein the container means 5 may house the device and the associated hardware. The container means 5 may be a receiving unit 7 that may house the flashing signal 9. The flashing signal may be composed to signal a plurality of directional instructions.

It should be appreciated that while preferred embodiments utilize a u-turn flashing signal 9 wherein the U-turn is typically made as a left turn, it should be understood that for markets where drivers drive on the opposite side of the street, the U-turn signal may be designated to show an appropriate U-turn for those mark as illustrated in FIG. 2.

As further illustrated in FIG. 1, the safety device 1 may be housed in a container means 5. The container means 5 may be constructed of any suitable material including plastic, metal, wood, polyurethane and the like. In a exemplary embodiment of the present invention, the container means 5 may be constructed of high temperature resistant plastic. The high temperature resistant plastic may be advantageous because of the temperatures that are sometime seen in hot areas and the exposure to heat and sunlight by the safety device. The container means 5 may be placed within a vehicle and may receive a signal from a sending unit 13 as illustrated in FIG. 7. Additionally, housed within the receiving unit 9, there may be a plurality of signal lights 15. The signal lights 15 may be activated after receiving a signal from the sending unit 13, whereby they would be illuminated to show the driver's desire to make a U-turn.

The U-turn receiving unit 9 as illustrated in FIGS. 1 and 2, may be in an exemplary embodiment, placed in the rear window of a vehicle (not shown), with sufficient visibility to vehicles behind the device 1 to be able to identify the flashing signal lights 15. In another exemplary embodiment, the receiving unit 9 may be placed in the front windshield of a vehicle(not shown) wherein the flashing lights 15 of the device 1 may be visible to vehicles ahead and to the periphery of the vehicle desiring to make a U-turn. The flashing lights 15 may utilize a plurality of colored bulbs including yellow, amber, red or any other color to signal a U-turn. The configuration of the bulbs may be designed in an exemplary embodiment with a series of LED type bulbs or a solid light. Additionally, the device 1 may have a cover plate 8 which may allow the image of the U-turn to be isolated. This cover plate 8 is further illustrated in FIG. 6. It should be noted that the exterior shaping of the receiving unit 7 may be customized to any shape such as round, square, heart and/or in the shape of letters, numbers, ect.

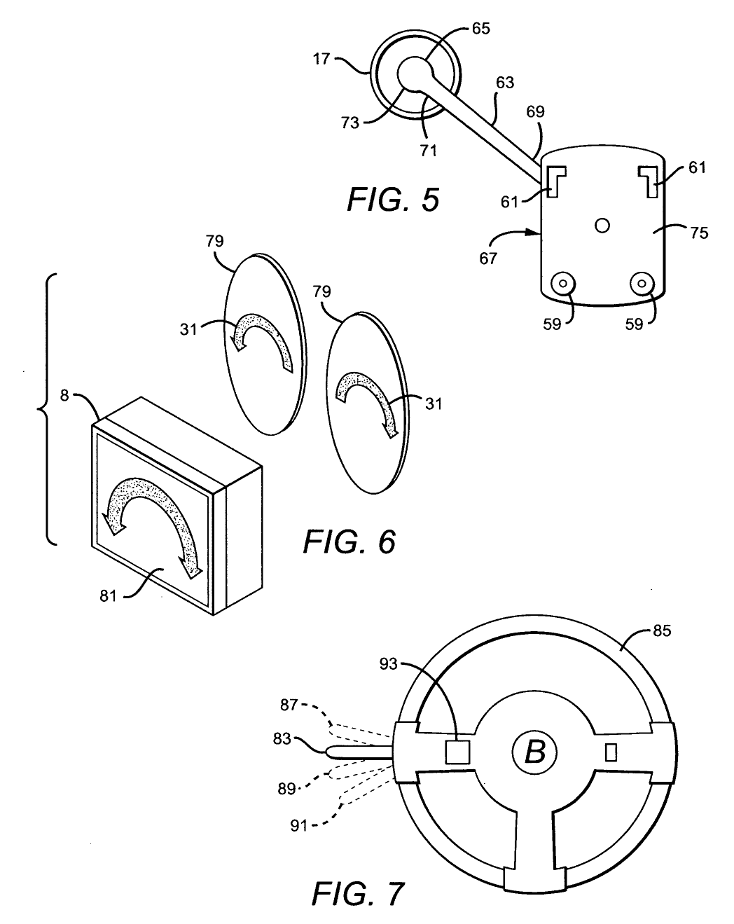

The U-turn device 1 may be adhered to a windshield (not shown) by a swivel suction cup 17 illustrated in FIG. 5, which may allow the device 1 to be positioned in a particular manner to the windshield to be in plain site of other vehicles around the vehicle wishing to make the U-turn.

FIG. 3 illustrates a sending unit 21 which may send a signal to the receiving unit 9. The sending unit 21 may have a housing 23 which may contain a signal transmitter 25. The transmitter 25 may send a signal to the receiving unit 9 which in turn activates the flashing lights 15 of the receiving unit indicating that the driver wishes to make a U-turn. In an exemplary embodiment, the transmitter 25 may use a radio frequency transmission to send the signal for the receiving unit 25 to activate. The receiving unit 9 may have a corresponding signal receiver 27 incorporated into the receiving unit 9 whereby the receiving unit 9 may receive the signal from the transmitter 25 and may be activated to turn on the flashing lights 15 in response to receipt of the signal.

The device 1 sending unit 21 may have a wireless control portion 29 contained therein, which when actuated, may send a signal to the receiving units placed in the front of the vehicle and the rear of the vehicle. The U-turn symbol, preferably exhibiting an arrow 31 as illustrated in FIGS. 1 and 2, may then flash in the receiving device to alert oncoming and following vehicles of the driver's intent to make a U-turn. The wireless control portion 29 may have a flashing light 35 to assure the driver that the signal has been properly transmitted to the receiving units located inside the vehicle. When the driver has completed his U-turn or decides against making a U-turn and wishes to turn the device 1 off, the driver will simply turn off the device 1 either manually by actuating a switch or automatically in a manner similar to the automatic cancellation switches currently employed in most vehicles relating to turn signals. Additionally, the device 1 may be deactivated or turned off using a timing mechanism wherein after a pre-determined period of time the unit will automatically reset to the off state. In an exemplary embodiment, the unit may be pre-set to turn off after sixty seconds automatically if not manually turned off by the user. In yet another exemplary embodiment, the unit may be deactivated or turned off by voice activation. After the U-turn has been completed, the unit may be turned off by voice command of the user.

The wireless remote device 21 may be attached to any part of the vehicle including the dashboard, visor, or any other interior area where the driver finds convenient. The wireless remote device 21 may be attached to the interior of the vehicle with an adhesive component or clip (not shown).

The sending unit may be a Radio Frequency (RF) activated circuit board that may send a UHF signal which does not require line of sight transmission. The board, in an exemplary embodiment, may be contained in a plastic or metal container and may be powered by a power source. In an exemplary embodiment, the power source may be a battery. Other types of power sources may be utilized including tapping into the power supply of the vehicle. The RF, UHF or any other utilized transmitting signals will not interfere with other vehicles in close proximity of the device utilized vehicle. In an exemplary embodiment, the LED light bulb may be seen up to or beyond an intersection. The use of a solar power system may be contemplate 8d to power the safety device as well as other types of direct current converts to increase power and voltage if desired.

FIG. 4 illustrates the back portion 37 of the safety device unit. The back portion 37 may provide for an area on the unit to power the unit 1. In an exemplary embodiment, the safety device unit may be powered with a power source 39. In an embodiment, the power source 39 may be a battery 41. Additionally, the back portion 31 may have an attachment means 43 whereby the attachment means 43 allows for attachment of the safety unit 1 to the windshield or other surface of a vehicle. In an embodiment, the safety device attachment means 43 may be an adhesive. Additionally, the attachment means 43 may be a suction cup 45 and/or a connection point 47 for attachment to a swivel arm 51 illustrated in FIG. 5. Additionally as illustrated in FIG. 4, a microphone 55 may be incorporated into the back portion 37 of the device 1 wherein when a user desires to activate the device 1, the microphone 52 will receive the direction from the use and send a signal to a processor (not shown) to activate the device 1. However, it should be understood that a plurality of attachment means 43 may be employed to attach the device 1 to the a portion of the vehicle. In an exemplary embodiment, the attachment means may be incorporated into any position in the device.

FIG. 5 illustrates the swivel cup connector 17. The swivel cup connector 17 may connect the safety device 1 or the send unit 21 to a surface of the interior of the vehicle to which it is attached. The swivel cup connector 17 may have a plurality of suction cups 59 thereon to attach the connector to the device. Additionally, the connector may have a plurality of different connection means 61 to be detachably connected to the device including adhesives, screws, snap-ons among others. Additionally the connector may have an arm 63 wherein the arm may be adjustable to move in any direction to fit any desired space. Moreover the arm 63 may allow for flexing the unit about the connector 17 such that the device may be moved, adjusted or rotated for maximum visibility by surrounding vehicles. The arm 63 may have a first connection point 65 at a first end 71 of the arm and a second connection point 67 at the second end of the arm 69. The first connection point 65 and the second connection point 67 may be adapted to be removably attached to a first contact portion 73 and a second contact portion 75. The first contact portion 73 may be attached to the interior portion of a vehicle, wherein the second contact portion 75 may be attached to the device 1. Where a device 1 may be moved from vehicle to vehicle, the entire arm assembly 17 would not need to be removed from the vehicle. If desired, a user could simply remove the second contact portion 75 and withdraw the device 1 from the vehicle and place it in another vehicle leaving the arm 62 and other contact portions still intact in the original vehicle.

FIG. 6 illustrates the device 1 having a cover plate 8. The device 1 may have a plurality of arrows 31 to indicate a U-turn, and also have an insert 79 that may be placed in a position posterior to the cover plate 8 wherein the insert 79 may black out portions of the sign such that the device 1 will indicate the desired finction of the insert 79. In practice, the insert 79 will be placed on top of the front portion 81 of the device 1 and the cover plate 8 placed on top of the insert 79. The insert 79 in an exemplary embodiment will black out a portion 81 of the standard sign such as a first side of the arrow 31 to properly indicate a conventional U-turn.

FIG. 7 illustrates a typical turn signal switch 83 that most vehicles have. Typically, the turn signal switch 83 is located to the left of the steering wheel 85 and is connected to the steering column (not shown). When a driver desires to make a right turn, the driver will move the switch in the upwards direction and the switch 83 will move into position A 87. When the driver desires to make a left turn, the driver will move the switch 83 in the downward direction and the switch will move to position B 89. In an exemplary embodiment, when the driver desires to make a U-turn, the driver will simply move the switch in a further downward position such that the switch is in position C 91. Thereby, the use of the turn signals and integrated U-turn signal within existing vehicle signals and/or side view mirror (both the front portion and the rear portion of the mirror) may be wirelessly or hardwired to the car's electrical system and effectuated with simple further movements of a commonly used indicator switch 83 located in most vehicles.

Additionally, FIG. 7 further illustrates the voice activation microphone 93 that may be located on the steering wheel assembly itself. However, it should be understood that the microphone 93 may be located at any location in the interior portion of the vehicle. Whereby a driver desiring to make a U-turn may activate the device 1 unit by simply instructing the unit to engage. The voice activation system having a microphone 93 on the steering wheel 85 will then activate the device 1 to show the driver's desire to make a U-turn. The voice activated system if further illustrated below.

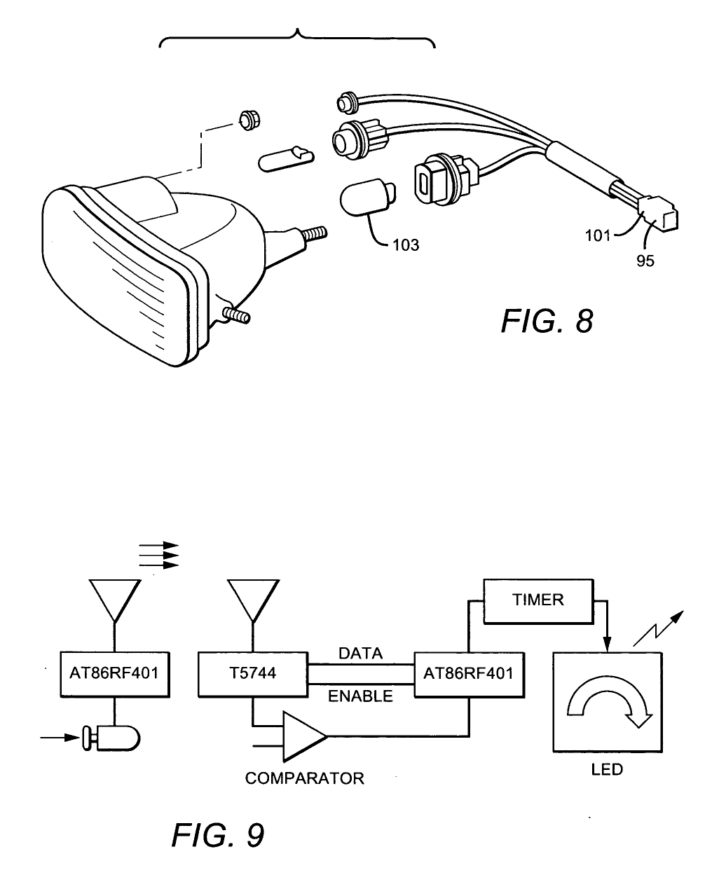

FIG. 8 illustrates the wiring schematic. The system may use a one way RF system which is comprised of an AT86RF401 transmitter (not shown) and a receiver chip 95 working at 314 MHz. When the U-turn activation button is pushed a unique 8 bit device identity code is sent to the receiver. The receiver chip 95 decodes the received signal into a digital signal and presents it to the microcontroller 101. Once the receiver 95 identifies that compatible code a signal activates the timer which keeps the LED flashing lights 103 of the U-turn device flashing for a period of time.

FIG. 9 illustrates the U-turn circuit that may be added to a OEM turn light assembly. In an exemplary embodiment, the vehicle may have an additional circuit that may be added to an existing turn light assembly during vehicle assembly to utilize the U-turn device in an OEM fashion.

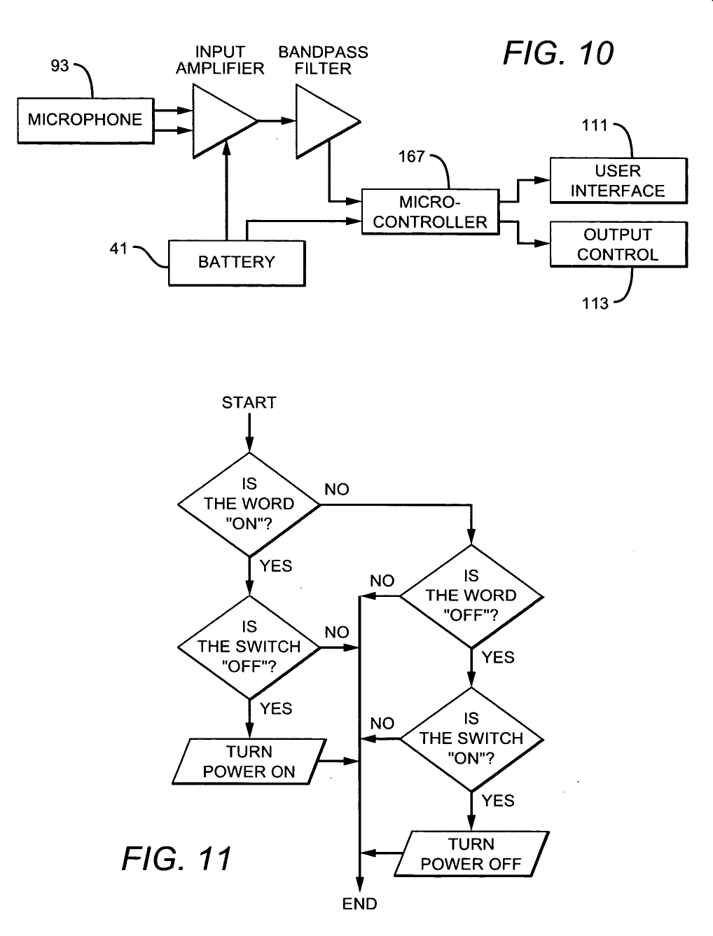

FIG. 10 illustrates the voice activation and/or recognition system. The voice activation system will allow multiple voice patterns and speech levels or accents to activate the system. In an exemplary embodiment, only a specific individual voice command will activate the system via a microphone 93. In another exemplary embodiment, the voice activation system may be utilized to turn on the motor, lights, lower and close windows and control other electrical system in the vehicle including radio and Heating and Air Conditioning units.

The voice activation system may have a microphone 93 that accepts and converts audio transmissions to electrical audio signals. These signals may be transmitted to speech processors which integrate speech optimizing digital and analog processing blocks. The speech processors may contain a memory module that stores the programming, and a speech command memory which stores speech commands. The voice activation system may also have a microcontroller 167 or processor that may control the LED sending unit 21 which may signal a driver that the unit 1 is operating correctly. The signal is then sent to a user interface 111 which outputs 113 the resulting flashing lights of the safety device unit. FIG. 11 illustrates the voice activation system logic sequence for determining if the device unit should be activated or not.

Thus, specific embodiments and applications of a safety device system have been disclosed. It should be apparent, however, to those skilled in the art that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A wireless vehicle safety system, the system comprising:
a U-Turn signal device configured to illustrate a driver desire to make a U-turn;
a transmitting unit; and
a receiving unit wherein the receiving unit activates the U-turn signal device.

2. The wireless vehicle safety system claim 1, wherein said U-turn signal device has an insertable plate.

3. The wireless vehicle safety system of claim 1, further comprising:
a power source to power the U-turn signal device.

4. The wireless vehicle safety system of claim 1 wherein the device may removably attached to an interior portion of a vehicle.

5. The wireless vehicle safety system of claim 1, further comprising:
an attachment means wherein the attachment means has an arm and a plurality of connection portions wherein the connection portions attach to the U-turn signal device and further wherein the connection portion attaches to a portion of the interior of a vehicle.

6. The wireless vehicle safety system of claim 1 further comprising:
a plurality of flashing lights incorporated into the U-turn signal device.

7. The wireless vehicle safety system of claim 1, further comprising:
a power source to activate the U-turn signal device.

8. The wireless vehicle safety system of claim 1 further comprising:
an indicator adapted for placement in the interior portion of a vehicle to indicate to the driver that the U-turn signal device is activated.

9. The wireless vehicle safety system of claim 1 further comprising:
a voice activation mechanism wherein the upon voice recognition, the U-turn signal device is activated.

10. The wireless vehicle safety system of claim 1 further comprising:
a radio frequency circuit board in the receiving unit.

11. A vehicle safety device comprising:
a container means for housing the device;
at least a light source whereby the light source is housed within the container means; and
a receiver unit to receive a signal from a transmitting unit; and
a power source.

12. The vehicle safety device described in claim 11 further comprising:
an actuator wherein the actuator activates the vehicle safety device.

13. The vehicle safety device described in claim 11 further comprising:
an attachment means for attaching the device to a portion of a vehicle.

14. The vehicle safety device described in claim 11 further comprising:
an activator having a light source thereon to indicate to a driver that the device has been activated.

15. The vehicle safety device described in claim 11 further comprising:
a voice activation system whereby the voice activation system activates the transmitting unit to send a signal to the receiving unit which in turn activates the vehicle safety device.

16. A method for using a vehicle safety system, said method comprising the steps of:
providing a U-Turn signal device configured to illustrate a driver desire to make a U-turn wherein the U-turn signal device contains a light source to illuminate the signal device indicating a driver intention to make a U-turn;
providing a transmitting unit; and
providing a receiving unit having a radio frequency device that will not interfere with any other electrical device wherein the receiving unit activates the U-turn signal device.

17. The method of claim 16, further comprising the step of:
a driver utilizing an actuation button.

18. The method of claim 16, further comprising the step of:
the transmitting unit sending a wireless signal to the receiving unit to activate the U-turn signal device.

19. The method of claim 16, further comprising the step of:
providing a power source to power the wireless transmitting unit, receiving unit and U-turn signal device.

20. The method of claim 16, further comprising the step of:
providing an indicator mechanism whereby the indicator mechanism indicates to the driver that the U-turn signal device is operating.

21. The method of claim 16, further comprising the step of:
allowing the driver to cancel the U-turn signal device whereby the driver de-activates a actuation button to cancel the signal device.
